(19) United States
(12) Patent Application Publication
(10) Pub. No.: US 2018/0301278 A1
(43) Pub. Date: Oct. 18, 2018

(54) AN INDUCTIVE DEVICE, A COIL FORMER AND A MANUFACTURING METHOD

(71) Applicant: HÖGANÄS AB (PUBL), Höganäs (SE)

(72) Inventor: Fredrik AF EKSTRÖM, Helsingborg (SE)

(73) Assignee: HÖGANÄS AB (PUBL), Höganäs (SE)

(21) Appl. No.: 15/569,516

(22) PCT Filed: Apr. 27, 2016
(86) PCT No.: PCT/EP2016/059352

§ 371 Date: Oct. 26, 2017

(30) Foreign Application Priority Data
Apr. 29, 2015 (EP) 15165748.3

(51) Int. Cl. H01F 27/30; H01F 17/04; H01F 27/02; H01F 27/32; H01F 5/02; H01F 27/26

(52) U.S. Cl. CPC H01F 27/306; H01F 17/043; H01F 27/26; H01F 27/324; H01F 5/02; H01F 27/022

(57) ABSTRACT

Disclosed herein are embodiments of an inductive device comprising: a winding defining an axial direction; a coil former; and a magnetic core comprising a base core portion from which an outer core portion and an inner core portion extend in the axial direction so as to form a void for accommodating the coil former and the winding; wherein the coil former comprises one or more walls together defining a void for receiving the winding and separating the winding from the inner core portion and from the outer core portion.

### TECHNICAL FIELD

The present disclosure relates to an inductive device, a coil former and a method for manufacturing an inductive device.

### BACKGROUND

Examples of inductive devices include transformers and inductors, sometimes also referred to as reactors or chokes.

Inductors are used in a wide array of applications such as signal processing, noise filtering, power generation, electrical transmission systems etc. In order to provide more compact and more efficient inductors, the electrically conducting winding of the inductor may be arranged around an elongated magnetically conducting core, also referred to as magnetic core.

Inductive devices are available in a large variety of designs and materials, each having their specific advantages and disadvantages. However, in view of the ever increasing demand for inductive devices in different applications there is still a need for inductive devices having a flexible and efficient design and which are usable in a wide range of applications.

Magnetic cores for inductive devices may be manufactured by pressing a soft magnetic powder material, e.g. an iron powder. The powder may be put into a cavity wherein the powder may be compacted.

Magnetic cores for inductive devices may be manufactured in a variety of designs. One design of magnetic cores, sometimes referred to as a pot core design, the magnetic core includes a base core portion from which an outer core portion and an inner core portion extend in an axial direction. The inner core portion and the outer core portion define a void between them for accommodating the winding where the winding is arranged around the inner core portion. Inductive devices of this type provide a high degree of shielding against electromagnetic fields which otherwise may effect other electrical components in the vicinity of the inductor. Such inductive devices are often provided with a coil former, often also referred to as a bobbin around which the winding is wound.

U.S. Pat. No. 4,549,158 discloses a prior art inductor of the type that includes a coil bobbin engaged by a pair of pot cores. The bobbin comprises a cylinder around which the winding is wound and respective upper and lower flanges at opposite ends of the cylinder.

U.S. Pat. No. 3,430,174 describes an inductance coil utilizing a pot type magnetic core in which the coil windings on a bobbin are incased in a mould of insulating thermoplastic resin prior to assembly. By this method, it is possible to obtain a pot-type magnetic core coil having a high dielectric breakdown voltage while maintaining a compact design and, in particular a small distance between the coil windings and the magnetic core.

However, it remains desirable to provide improved inductors that allow an efficient manufacturing and assembly.

### SUMMARY

Disclosed herein are embodiments of an inductive device comprising:

a winding defining an axial direction;

a coil former; and

a magnetic core comprising a base core portion from which an outer core portion and an inner core portion extend in the axial direction so as to form a void for accommodating the coil former and the winding;

wherein the coil former comprises one or more walls together defining a void for receiving the winding and separating the winding from the inner core portion and from the outer core portion.

Consequently, the coil former and winding may be assembled with the magnetic core in an efficient manner while the coil former provides efficient insulation between the winding and the magnetic coil.

Moreover, embodiments of the inductive device provide a volume and weight efficient inductive device in a cost-efficient and comparably simple manner.

In some embodiments, the coil former comprises one or more end walls, an inner wall and an outer wall. The inner wall extends in the axial direction from one of the one or more end walls. The outer wall extends in the axial direction from one of the one or more end walls, e.g. from the same end wall as the inner wall or from an opposite end wall. The inner wall is radially further inward than the outer wall as seen relative to the longitudinal axis of the coil which defines the axial direction. The inner wall is interposed between the inner core portion and the winding so as to separate the inner core portion from the winding, and the outer wall is interposed between the outer core portion and the winding so as to separate the outer core portion from the winding. In particular, the inner wall may form a separating layer having a radially inward-facing surface that faces the inner core portion and a radially outward-facing surface which faces the winding. Similarly, the outer wall may form a separating layer having a radially inward-facing surface which faces the winding and a radially outward-facing surface which faces the outer core portion. In particular, the separating layers may be insulating layers.

The inner and outer walls may each be tubular, i.e. extending at least partially around a circumference around the coil axis. The outer wall and the inner wall may thus define an annular void between them which accommodates the winding. In some embodiments, the inner and/or the outer wall may be formed as a partial cylinder, e.g. not completely surrounding the entire outer circumference of the winding but defining one or more axial slits in the outer wall.

One or more of the walls may be formed as a continuous wall or it/they may be interrupted by one or more apertures.

In some embodiments, the coil former comprises first and second end walls axially spaced apart from each other; and wherein the inner wall and the outer wall extend in the axial direction between the end walls so as to define an annular void between the inner and outer walls for accommodating the winding. The first end wall is interposed between the base core portion and an end face of the winding.

For the purpose of the present description the terms radial, axial and circumferential are intended to refer to the respective directions of a cylindrical coordinate system defined relative to the axial direction of the winding.

In some embodiments, the inner core portion, the inner wall, the winding, the outer wall and the outer core portion are arranged coaxially around the axial direction, with the inner core portion positioned radially most inward, successively surrounded by the inner wall, the winding, the outer wall and the outer core portion.

The winding typically comprises a plurality of turns. The turns define a central hole through which, during operation, the magnetic flux extends which is caused by electrical current through the turns of the winding. The axial direction is defined by the turns of the winding as the direction of the magnetic flux through the center of the turns of the winding. The winding may be substantially cylindrical, although other geometries are possible as well.

In some embodiments, the coil former comprises two separate coil former components that are attachable to each other during assembly. Each coil former component may form a receptacle, e.g. a cup-like receptacle, for receiving a part of the winding, e.g. half of the winding. The coil former component may comprise an end wall and an outer wall extending from the end wall, e.g. in the axial direction. The coil former component may thus have an open end, e.g. defined by a rim of an end of the outer wall facing away from the end wall. The coil former components may thus be fitted over opposite axial ends of the winding with their open ends facing each other, such that the open ends of the coil former components are attached to each other so as to form an enclosure accommodating the winding.

In some embodiments, the coil former comprises first and second end walls, a hollow elongated inner member formed by the inner wall and extending along the axial direction from the first end wall towards the second end wall; wherein the inner member defines an inner void and wherein the inner member and the outer wall together define a void/cavity for receiving the winding, e.g. a void/cavity having an annular cross section. In some embodiments the inner core portion of the magnetic core extends into the inner void defined by the inner member of the coil former, e.g. such that the inner member circumferentially surrounds the inner core portion.

In particular, a first coil former component may comprise the first end wall and at least a first part of the inner member and/or at least a first part of the outer wall; while the second coil former component comprises at least the second end wall.

In some embodiments, the first coil former component comprises the first end wall, a first inner member part and a first outer wall part, the first inner member part and the first outer wall part extending from the first end wall towards the second end wall; and wherein the second coil former component comprises the second end wall, a second inner member part and a second outer wall part, the second inner member part and the second outer wall part extending from the second end wall towards the first end wall, such that the first and second inner member parts together form the inner member when the first and second coil former components are assemble with each other, and wherein the first and second outer wall parts together form the outer wall when the first and second coil former components are assemble with each other. Each of the first and second coil former components may thus have a closed end, which is closed by the respective first or second end wall, and an open end, and the first and second coil former components may be configured to be joined with their open ends facing each other.

One of the first and second coil former components may be configured such that at least a portion of its outer wall part is axially slidable into the open end of the other coil former component. In some embodiments, the coil former components may be configured so as to allow a portion of the outer wall part of one of the coil former components to be axially slidable into the open end of the other coil former component and retained at one or more selectable insertion depths. For example, this may be achieved by a snap joint or other retaining member allowing insertion and of one of the coil former components into the other coil form component at different insertion depths and preventing detachment of the coil former components from each other. Consequently, coil formers of different axial length may be assembled from a limited number of different types of components, as a given pair of coil former components can be assembled so as to selectably form a coil former of a plurality of axial lengths, i.e. so as to fit into magnetic cores of different axial lengths.

The first and second coil former components may have substantially the same size and shape whereas, in other embodiments, the coil former components may be different from each other.

In some embodiments, the coil former components and the magnetic core are arranged coaxially with the winding.

In some embodiments the outer wall comprises an aperture through which winding leads may project from the winding and out of the coil former. In some embodiments, the outer core portion of the magnetic core has an aperture that is axially and circumferentially aligned with the aperture in the outer wall of the coil former. In some embodiments the coil former comprises a radially outward protruding wall that protrudes from the outer wall outwards and that extends along a periphery of the aperture so as to form a frame or skirt that partially or completely surrounds the aperture. The outwardly protruding wall may have a width (in the radial direction) corresponding to a wall thickness of the outer portion of the magnetic core. At the outer edge of the outwardly protruding wall portion, a lip may be provided which extends from the outer edge of the outwardly protruding wall away from the aperture.

In some embodiments, the inductor device comprises a flow channel defined between an inner surface of the magnetic core and the outer surface of one or both end walls of the coil former and/or the outer surface of the outer wall of the coil former, the flow channel defining an inlet port for inserting a liquid curable material, such as epoxy, polyurethane or a similar resin, into the flow channel and allowing the curable material to fill a void between the outer surface of the coil former and the inner surface of the magnetic core.

To this end, the coil former may comprise one or more channels or grooves formed in the outer surface of one or both end walls of the coil former and/or the outer surface of the outer wall of the coil former. In some embodiments, one or more channels are formed along a periphery of one or both of the end walls, e.g. along a bend defined between the inner member and an end wall and/or along a bend defined between the outer wall and an end wall.

The coil former may further be provided with one or more holes or channels providing a fluid conduit connecting the flow channel with the void defined between the inner member and the outer wall of the coil former, so as to allow the curable material inserted into the inlet port of the flow channel to enter said void between the inner member and the outer wall of the coil former. In some embodiments, the holes of channels are formed at a first exterior surface position of the coil former and the feeding point is located at a second exterior surface position of the coil former, opposite the first exterior surface position. Hence, when the inductive device is positioned with the first exterior surface position pointing downwards, the inlet port faces upwards, thus allowing the curable material to be inserted into the flow channel extending along the exterior surface of the coil former and to enter the void defined inside the coil former through the one or more holes or channels. Hence, any space inside the coil former which is left unoccupied by the winding may be filled by the curable material from below in an efficient manner avoiding inclusions of gas.

In some embodiments, a part of the flow channel extends axially along the exterior surface of the outer wall, e.g. from the first end wall to the second end wall, so as to allow the curable material to flow along the entire axial length of the coil former. In some embodiments the one or more holes or channels are formed in the part of the flow channel extending axially along the exterior surface of the outer wall. In some embodiments the part of the flow channel extending axially along the exterior surface of the outer wall is located opposite a position of an aperture in the outer wall through which the lead wires of the coils project outwards.

The coil former may be made from an injection-moldable material such as a thermoplastic material, e.g. LCP (liquid crystal polymer), PPS or a similar thermoplastic material.

In some embodiments the coil former comprises mounting elements, such as slits for connecting one or more electrical connectors. The mounting elements may be arranged along the rim of an aperture in the outer wall of the coil former through which aperture the lead wires extend outwards. The mounting elements may be configured to allow a slidable connection of the connector or connectors e.g. along the axial direction and/or along a circumferential direction.

The magnetic core may be made of a compressed soft magnetic powder material.

In some embodiments the magnetic core is of the potcore type. It may be formed by at least two core components: A first core component comprises the base core portion and at least a part of the outer core portion and/or at least a part of the inner core portion. A second core component comprises an end portion—e.g. a further base core portion—opposite the base core portion of the first core component, and complementary parts of the inner core portion and/or the outer core portion, such that the first and second core components, when assembled with each other, form the magnetic core. It will be appreciated that, in some embodiments, the first and second core components may be identical, thus forming two halves of the magnetic core while, in other embodiments, the first and second components may be different from each other. For example, in some embodiments, the first component may comprise the base core portion and the entire outer core portion and the entire inner core portion so as to form a receptacle for receiving the coil former and the winding. In such an embodiment, the second core component may be formed as a lid for closing the open end of the first core component. In alternative embodiments, the first core component may comprise the base core portion and the entire outer core portion while the second core component comprises an end portion and the entire inner core portion. In yet another embodiment, the first core component may comprise the base core portion and the entire inner core portion while the second core component comprises an end portion and the entire outer core portion. It yet other embodiments the inner core portion and the outer core portion may be distributed between the first and second core components in a different manner. In some embodiments, each magnetic core component forms a receptacle for receiving a part, e.g. one halve, of the coil former and the winding.

In some embodiments, the base core portion has an inner surface and an opposite, outer surface; wherein the inner core portion and the outer core portion axially extend from the inner surface. The outer core portion at least partly surrounds the inner core portion, thereby forming the void around the inner core portion for accommodating the winding.

In some embodiments, the inner surface comprises a recess for accommodating a lead wire of the winding, said recess extending at least a part of a distance between the inner core portion and the outer core portion, and wherein the outer core portion defines an aperture, e.g. in the form of a slit, extending from the end wall at the position of the recess. The outer core portion may be formed as a wall extending axially from the inner surface and having an end facing away from the inner surface. The aperture may be formed as a slit extending axially from said end to the inner surface. By virtue of the recess and the aperture, the lead wire of the winding may be conveniently arranged to extend through the aperture and inside the recess without occupying any valuable winding space within the magnetic core. In some embodiments, the outer surface comprises an elevated area opposite to the recess. The elevated area opposite the recess makes it possible to manufacture a magnetic core including a recess and an aperture in a single pressing operation i.e. without requiring any aftermachining (such as a separate milling process). Furthermore, this may be achieved using a comparably simple press, e.g., without requiring any additional independently controllable punch. The elevated area adds to the second surface at least some of the volume which is occupied by the recess, i.e. lost in the base core portion in order to form the recess, and thereby makes formation of the base core portion possible by reducing any biasing of the punch which otherwise may be caused by the presence of the recess. Consequently, the magnetic core may be manufactured in a cost and time efficient manner using a relatively simple press. In some embodiments, the end portion of the magnetic core opposite the base core portion may also comprise one or more recesses on its inner surface and, optionally, one or more corresponding protrusions on its, outer surface as described in connection with the base core portion.

The flow channel may be formed such that it is in fluid communication with the recess such that the void defined between the end wall of the coil former and the inner surface of the base core portion may be filled by a curable material. The recess may even form a part of the flow channel when the recess is in fluid communication with an upstream part of the flow channel and a downstream part of the flow channel. For example, the recess may provide a radial flow channel, while one or more channels along the periphery of the end wall of the coil former form circumferential parts of the flow channel, e.g. for providing fluid communication between multiple recesses. In particular, according to one embodiment, the inner surface comprises at least two recesses, said at least two recesses extending at least a part of a distance between the inner core portion and the outer core portion, and wherein the recesses are in fluid communication with each other via the flow channel.

According to one embodiment, a recess extends to an outer edge of the inner surface of the base core portion.

According to one embodiment the aperture extends to the recess such that the aperture joins the recess wherein the recess forms a periphery of the aperture.

According to one embodiment, the dimension of the outer core portion in the axial direction away from the inner surface exceeds the dimension of the inner core portion in the axial direction away from the inner surface.

In some embodiments, the magnetic core comprises two magnetic core components, each comprising a base core portion, an inner core portion and an outer core portion; wherein a rim of the outer core portion of the first magnetic core component engages with a corresponding rim of the outer core portion of the second magnetic core component, and wherein the respective inner core portions of the first and second magnetic core components together form an elongated inner core portion defining an air gap. In some applications it may be desirable to use a magnetic core including an air gap since a properly arranged air gap inter alia may reduce the inductance sensitivity to current variations.

The magnetic core may be made from a soft-magnetic composite powder material. The powder material may be a ferrite powder, a high purity iron powder, a Fe—Si powder, other silicon-alloyed powders, an iron-phosphorous alloy or some other powder material with similar properties. Optionally, the material may be a soft magnetic composite powder material including a soft magnetic powder (e.g. iron) provided with an electrically insulating coating. Examples of composite materials that may be used are Somaloy 110i, Somaloy 130i, Somaloy 500, Somaloy 700 and Somaloy 1000 which may be obtained from Höganäs AB, S-263 83, Höganäs, Sweden. According to one embodiment, the compressed soft magnetic powder material includes preferably at least 80% by weight of iron, more preferably at least 90% by weight of iron, and most preferably at least 95% by weight of iron. An increased percentage of iron may improve the compressibility of the powder.

The inductive device may be an inductor or a transformer or a similar device.

The present disclosure relates to different aspects including the inductive device described above and in the following and to corresponding methods and/or products. Each aspect may yield one or more of the benefits and advantages described in connection with one or more the other aspects, and each aspect may have one or more embodiments with all or just some of the features corresponding to the embodiments described in connection with one or more the other aspects and/or disclosed in the appended claims.

According to a further aspect, disclosed herein are embodiments of a coil former for an inductive device as described above and in the following.

According to yet a further aspect there is provided a method for manufacturing an inductive device as disclosed herein, the method comprising:

assembling the magnetic core, the coil former and the winding with each other; and

filling a void inside the magnetic core with a curable material.

The assembling may comprise attaching a first and a second coil former component with each other so as to form an assembled coil former component at least partially enclosing the winding.

The filling may comprise inserting, optionally under pressure, a curable material into the inlet port of a flow channel formed between an outer surface of the coil former and an inner surface of the magnetic core.

In some embodiments the method comprises inserting a liquid, curable material into the inlet port when the assembled combination of magnetic core, coil former and winding is placed with an aperture formed in the outer core portion of the magnetic core facing upwards. The method may thus comprise letting the liquid curable material to flow through the flow path so as to fill the voids between the outer surface of the end wall of the coil former and the inner surface of the base core portion. The method further comprises letting the liquid curable material further flow through one or more holes inwards into the void formed between the outer and inner tubular walls of the coil former. When the one or more holes are positioned at a lowermost position of the coil former when the coil former is positioned with the aperture and the inlet pointing upwards, the liquid, curable material enters the void inside the coil former from below, and the level of curable material inside the coil former rises gradually during the filling process, so as to fill any space inside the void that is left unoccupied by the winding. When the curable material reaches a desired level, e.g. the rim of the aperture, the filling process may be stopped and the curable material may be allowed to cure. Hence, an efficient filling process of the space surrounding the winding is provided while the inductor may be kept compact and a reliable insulation between the winding and the magnetic core is provided.

### BRIEF DESCRIPTION OF THE DRAWINGS

The above, as well as additional objects, features and advantages of the present inventive concept, will be better understood through the following illustrative and non-limiting detailed description of preferred embodiments of the present inventive concept, with reference to the appended drawings, where like reference numerals will be used for like elements, wherein:

FIGS. 1A and 1B are perspective views illustrating an embodiment of an inductor.

FIGS. 2A and 2B are perspective views illustrating an embodiment of an inductor core.

FIG. 3 is a top view of an inductor core.

FIGS. 4 and 5 are perspective views of a coil former.

FIG. 6 is a perspective view of an assembly of a coil former component and a winding.

### DETAILED DESCRIPTION

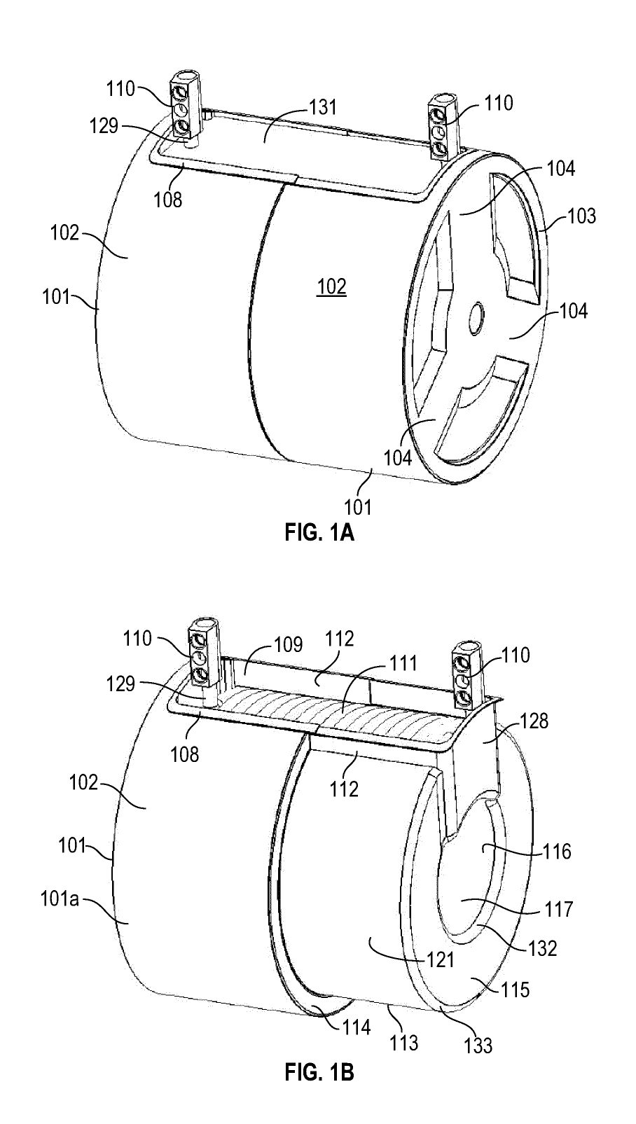

FIGS. 1A and 1B are perspective views illustrating an embodiment of an inductor. The inductor comprises a magnetic core, a winding 111, a coil former 113, and a curable material 131. The magnetic core is of the potcore type and comprises two separate magnetic core components 101. FIG. 1A shows the assembled inductor while FIG. 1B shows a partially assembled inductor where one of the magnetic core components and the curable material are removed.

Each of the magnetic core components form one halve of the assembled magnetic core. Each component is formed as a pot-shaped component comprising a base core portion 103, an inner core portion (not shown in FIGS. 1A-B) and an outer portion 102 forming a circumferential wall. Each magnetic core component thus has a closed end formed by the base portion 103 and an opposite open end delimited by a rim or end surface 114 of the outer core portion. The magnetic core components are assembled with the rims of their respective outer core portions facing each other. The end faces may abut each other or otherwise engage each other or be connected with each other.

The coil former is also assembled from two separate components each forming a part of the coil former. Each component is formed from injection-molded thermoplastic material and each component comprises an annular end wall 115 from which an outer tubular wall 121 and an inner tubular member extend along the axial direction of the winding 111; the inner tubular member is formed by an inner tubular wall 116. The annular end wall 115 defines an inner periphery 132 and an outer periphery 133. The inner tubular wall 116 extends from the inner periphery 132 and the outer tubular wall 121 extends from the outer periphery 133. One of the ends of the outer tubular wall 121 is closed by end wall 115 while the other end of the outer tubular wall 121, opposite the end wall 115, is open and defines an open end of the coil former component. The two coil former components are joined with their open ends facing each other, e.g. by a rim of one tubular wall being inserted in the corresponding other tube. Hence, the inner tubular members of the two coil former components form respective parts of a combined inner tubular member of the assembled coil former, and the outer tubular walls of the two coil former components form respective parts of a combined outer tubular wall of the assembled coil former, In the present example, the two coil former components have substantially equal axial length, but it will be appreciated that, in other embodiments, the shape and/or size of the coil former components may differ from each other. The inner and outer tubular walls thus define a void having an annular cross section for accommodating the winding 111 where the winding surrounds the inner tube formed by the inner tubular walls of the coil former components, and where the combined outer tubular wall surrounds the winding, except for an aperture 109 in the outer tubular wall as described below. The combined inner tubular wall and the central hole 117 of the end wall of each coil former component define a through hole through which the inner core portion of the magnetic core extends.

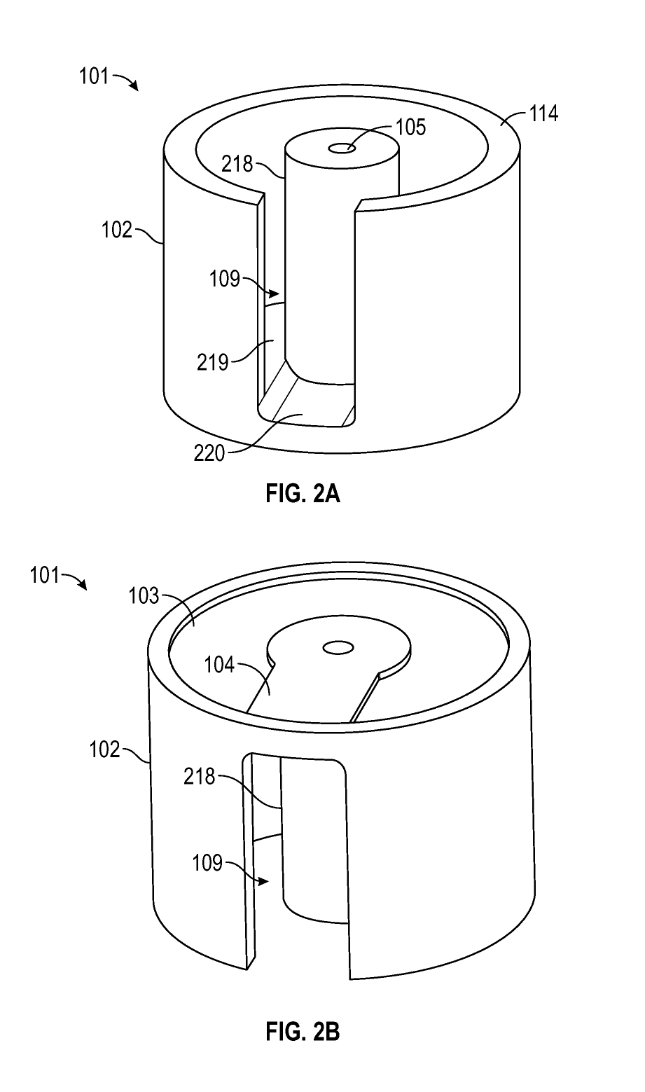

The outer core portion and the outer wall of the coil former each have an aperture through which lead wires 129 of the winding can extend radially outward so as form, or be connected to, electrical connectors 110, e.g. screw terminals or other forms of terminals for electrically connecting the inductor. In the present example, the apertures are formed as axial slits in the outer walls of the coil former components and as corresponding axial slits in the outer core portions of the magnetic core components. The slits are circumferentially aligned with each other and extend substantially along the entire axial length of the inductor. In the region of the aperture 109, the end wall 115 of the coil former has a protruding portion 128 which axially protrudes outwards as will be described in greater detail below. Similarly, the base core portion 103 of the magnetic core has a number of outwardly protruding portions 104, one of which is circumferentially aligned with the aperture 109 and with the protruding portion 128 of the end wall of the coil former. In the example shown in FIG. 1A, the base core portion comprises three such protrusions. However, it will be appreciated that other embodiments, e.g. as illustrated in connection with FIGS. 2A-B below, may comprise a different number of protrusions, e.g. a single protrusion, or no protrusion.

The rim of the aperture 109 formed in the outer tubular wall of the coil former is provided with an outwardly extending wall or skirt 112 having a width corresponding to the wall thickness of the outer core portion. The outermost edge of the outwardly extending wall 112 is provided with a lip 108 which extends away from the aperture such that the rim of the aperture in the outer core portion of the magnetic core fits in to a notch formed by the exterior surface of the outer tubular wall, the outwardly extending wall 112 and the lip 108.

FIGS. 2A and 2B are perspective views illustrating an example of a magnetic core component for an inductor, e.g. one of the magnetic core components 101 that form the magnetic core of the inductor of FIGS. 1A-B.

The magnetic core component 101 may be made of a compressed soft magnetic powder material and it comprises a disc-shaped base core portion 103. The base core portion 103 includes an inner surface 219 and an outer surface, opposite the inner surface. The magnetic core component further comprises an inner core portion 218, extending perpendicularly from the inner surface 219, thereby defining an axial direction. The inner core portion 218 has an annular cross section. The magnetic core component 101 further comprises an outer core portion 102 in the form of a tubular wall which extends in the axial direction from the inner surface 210 and whose opposite end defines a rim 114 of the outer core portion 102.

The inner core portion 218 extends from a center part of the base core portion 103 while the outer core portion 102 extends from a radially outermost periphery of the base core portion 103. When a magnetic core is assembled from two magnetic core components as the one shown in FIG. 2A, the outer core portions 102 together form a circumferential housing of the magnetic core. The magnetic core thus provides a magnetic flux path axially along the inner core portion, radially inward/outward through the disc-shape base core portions and a return path axially along the outer core portion.

As indicated in FIGS. 2A and 2B the inner core portion 218 may be provided with an axially extending hole. The hole may be a through-hole. The hole may be arranged to receive fastening means, such as a bolt or the like, for attaching the inductor core to an outer structure.

As illustrated in FIGS. 2A and 2B, the outer core portion 102 at least partly surrounds and is arranged coaxially with the inner core portion 218. Thereby, an annular void extending radially and axially between the inner core portion 218 and the outer core portion 102 is formed. In this space, a coil former and a winding may be arranged, e.g. as illustrated in FIGS. 1A-B where the inner core portion 218 extends through an central tubular void defined by the coil former as described above.

The outer core portion 102 includes a slit 109. The slit 109 extends from the rim 114 towards the inner surface 219 of the base core portion. The slit 109 extends through the full radial thickness of the outer core portion 102. The wall portions of the outer core portion 102 defining the slit 109 extend along the axial direction.

The inner surface 219 includes a recess 220 extending in the radial direction from the inner core portion 218 towards the slit 109, thereby joining the slit 109, wherein the recess 220 forms the bottom of the slit 109. At the radial position where the recess 220 joins the slit 109, the recess 220 and the slit 109 have approximately equal widths, i.e. equal circumferential dimensions.

The recess 220 is arranged to accommodate one or more connecting leads of one or more windings arranged around the inner core portion 218, e.g. as illustrated in the example of FIGS. 1A-B above. In particular, a lead wire from the inner turn of the winding may extend radially outwards in the recess 220 and through the slit 109. The slit 109 is arranged to provide a lead-through for a lead wire. Lead wires of one or more windings may thus be arranged through the slit 109 and along the recess 220 of the base core portion 103 towards the inner core portion 218 while occupying a minimum volume of the winding space.

The outer surface of the base core portion 103 comprises a protrusion 104. The protrusion 104 protrudes in the axial direction. The protrusion 104 extends in a radial direction from a central part of the outer surface towards an outer radial edge of the outer surface. The protrusion 104 is coextensive with the recess 220 by extending along, and in parallel with the recess 220.

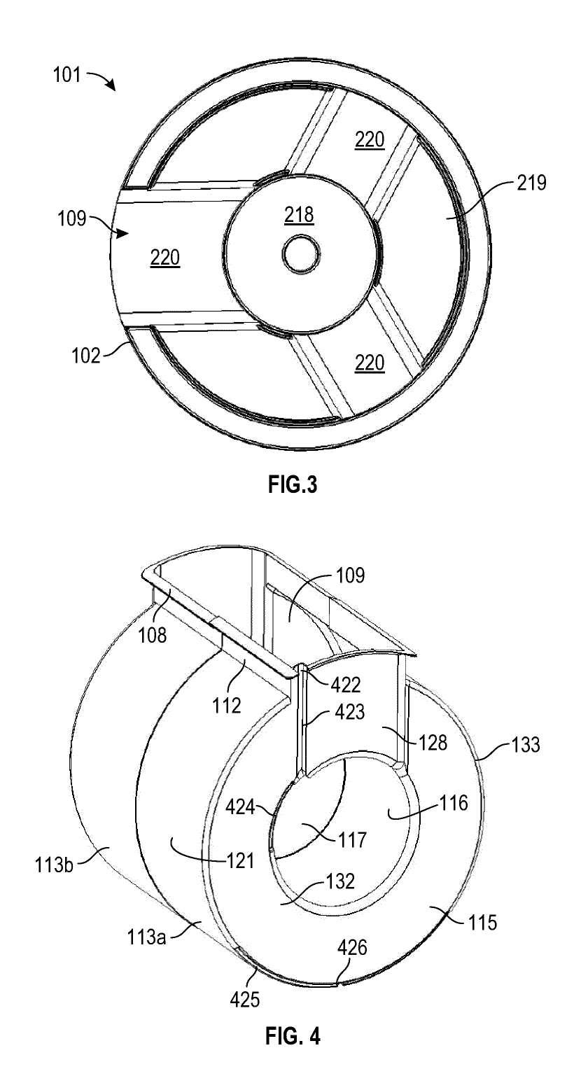

FIG. 3 is a top view illustration of one of the magnetic core components 101 of the inductor of FIGS. 1A-B, i.e. a view into the open end of the magnetic core component. The magnetic core component 101 is similar to the magnetic core component of FIGS. 2A-B but it differs in that it includes more than one recess. More specifically, the magnetic core component 101 of FIG. 3 comprises an inner core portion 218, an outer core portion 102 and a base core portion having an inner surface 219, all as described above. The inner surface 219 of the base core portion of the magnetic core component 101 of FIG. 3 includes three recesses 220. The recesses are symmetrically distributed on the inner surface with respect to an angular direction such that an angle of approximately 120° is formed between adjacent pairs of recesses. However other distributions are also possible. The outer core portion 102 comprises a slit 109 which extends from the rim of the outer core portion towards one of the recesses 220 which recess thus forms the bottom of the slit 109.

It should be noted that a magnetic core component may include a different number of recesses than one or three as described above. For example, a magnetic core component may include two recesses and two corresponding protrusions. In that case, the two recesses (and the two protrusions) may be arranged at an angle of 180° in relation to each other.

In the magnetic core components described above, one of the recesses 220 extends from the inner core portion 218 to the slit 109. According to an alternative embodiment, the radially innermost part of the recess 220 may be separated from the inner core portion 218 by a distance, i.e. a non-zero distance. This may be useful, for example, when using a multi-layer winding having a thickness such that the outer layer of the winding roughly coincides with the innermost radial part of the recess 220 wherein the connection portion of the winding which is to be accommodated in the recess leaves the winding at the innermost radial part of the recess 220.

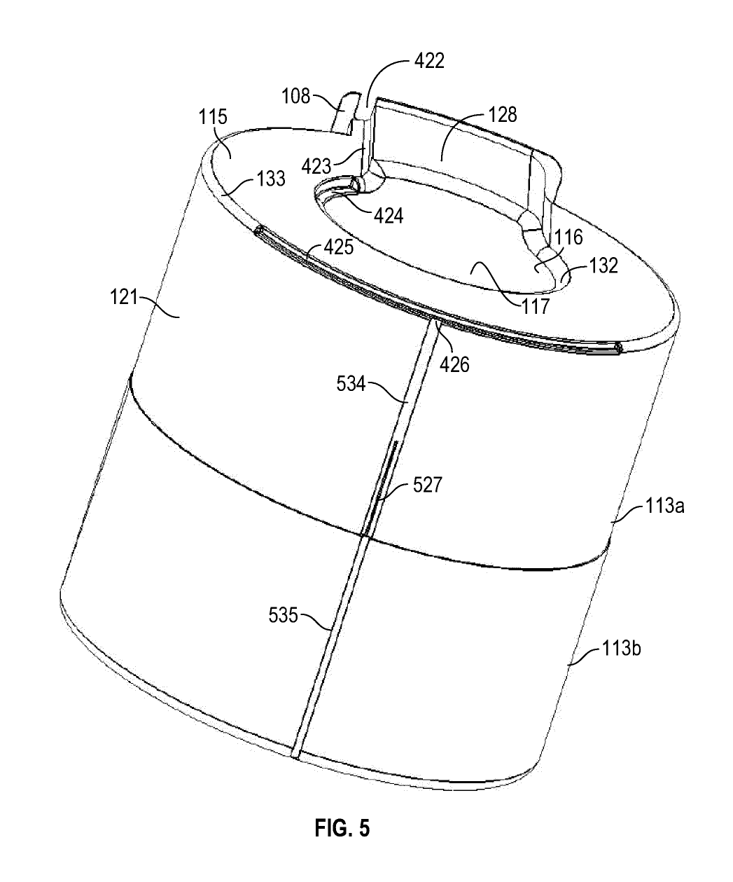

An example of a coil former will now be described with reference to FIGS. 4-6 and with continued reference to FIGS. 1A-B, 2A-B and 3.

FIGS. 4 and 5 show perspective views of an example of a coil former for an inductive device, e.g. for the inductor of FIGS. 1A-B. The coil former is assembled from two coil former components 113a and 113b, respectively. Each coil former component is formed from injection-molded thermoplastic material and it comprises an annular end wall 115, an inner tubular wall 116 and an outer tubular wall 121, as described in connection with FIG. 1B. The annular end wall 115 defines an outer periphery 133 and an inner periphery 132 around a central hole 117. The inner tubular wall 116 extends from the inner periphery and the outer tubular wall extends from the outer periphery 133. The two coil former components are joined with their open ends facing each other. When assembled, the inner and outer tubular walls thus define a void having an annular cross section for accommodating the winding 111 where the winding surrounds the inner tube formed by the inner tubular walls and where the outer tubular wall surrounds the winding, except for an aperture 109 in the outer tubular wall as described below. The inner tubular wall and the central hole 117 of the end wall of each coil former component define a tubular void into which the inner core portion of the magnetic core protrudes when the coil former is assembled with the magnetic core components. The outer tubular wall of each coil former component has an axial slit 109. In the assembled coil former component, the slits of both coil former components are circumferentially aligned with each other so as to form an aperture in the outer tubular wall 112 such that the aperture extends substantially along the entire axial length of the coil former. In the region where the slit 109 meets the end wall 115, the end wall 115 of each coil former component has a protruding portion 128 which axially protrudes outwards. The protruding region 128 is shaped, sized and positioned such that, when the coil former is assembled with a magnetic core, e.g. the magnetic core of FIG. 2A-B or 3, the protruding region 128 extends into a corresponding recess in the inner surface of the magnetic core, e.g. recess 220 of the magnetic core components of FIG. 2A-B or 3.

The rim of the slit 109 is provided with an outwardly protruding wall 112 that forms a frame or skirt around the aperture 119 and that has a width corresponding to the wall thickness of the outer core portion. The outermost edge of the wall 112 is provided with a lip 108 which extends away from the aperture such that the rim of the aperture.

The coil former component 113a is provided with a number of grooves or channels that provide a flow path for a curable material from an inlet port 422 along the outer surface of the end wall 115 to a position 426 at the outer periphery of the end wall opposite the position of the slit 109, and from said position axially along the exterior surface of the outer wall.

The inlet port 422 is located at a corner of the periphery of the slit where the axial part of the wall 112 joins the end wall 115. From the inlet port, a grove 423 extends to the periphery 132 of the central hole 117 of the end wall. In particular, the channel 423 extends along an edge of the protruding portion 128. The periphery 132 of the central hole 117 includes a channel 424 extending along a part of the periphery so as to provide a flow channel between inlet port 422 and channel 423 and a position on the exterior surface of the end wall which faces one of the recesses 220 of the inner surface 219 of the base core portion 103 of the magnetic core component 101 into which the coil former component 113a is inserted. Hence the void between the bottom of the recess 220 and the exterior surface of the end wall 115 may be filled with a curable material. The outer periphery 133 of the end wall 115 comprises a further grove 425 which extends along a part of the outer periphery. In particular, the channel 425 provides a flow channel between the position on the exterior surface of the end wall which faces the recess 220 which is connected in fluid communication to channel 423 and to a position 426 on the outer periphery 133 of the end wall from which an axial groove 534 extends along the exterior surface of the outer wall 121. The channel 425 may further provide a flow channel to one or more further positions on the exterior surface of the end wall. Such a further position may be a position that faces a further recess 220 in the inner surface of the magnetic core component. Hence the groves 423, 424 and 425 together with one or more of the recesses 220 provide an uninterrupted fluid conduit between the inlet port and all the recesses on the inner surface of the base core portion of the magnetic core. The outer wall 121 of the coil former component 113a further comprises an axially extending channel 534 extending from position 426 to an opposite end of the outer wall 121.

When the opposing coil former component 113b also comprises a corresponding axial channel 535 along its outer wall and a number of circumferential channels at its end wall an uninterrupted fluid conduit is formed from the inlet port 422 to all voids formed between the end walls of the coil former and the opposing inner surfaces of the magnetic core.

The channel 534 is further provided with one or more through holes providing a fluid conduit between the channel 534 and the interior void of the coil former where the winding is located. Consequently, a liquid, curable material may be inserted into the inlet 422 when the assembled combination of magnetic core, coil former and winding is placed with the aperture 109 facing upwards. The liquid curable material may be inserted under pressure. The liquid curable material may then flow through the flow path described above so as to fill the voids between the outer surface of the end wall 115 of the coil former and the inner surface 219 of the base core portion. The liquid curable material further flows through the hole or holes 527 inwards into the void formed between the outer and inner tubular walls of the coil former. As the hole or holes 527 are positioned at a lowermost position of the coil former when the coil former is positioned with the aperture and the inlet pointing upwards, the liquid, curable material enters the void inside the coil former from below, and the level of curable material inside the coil former rises gradually during the filling process, so as to fill any space inside the void that is left unoccupied by the winding 111. When the curable material reaches a desired level, e.g. the rim of the aperture 109, the filling process may be stopped and the curable material may be allowed to cure.

It will be appreciated that alternative embodiments of an inductive device may comprise a different geometry of flow channels. For example, in embodiments without significant voids between the exterior surface of the coil former and an inner surface of the magnetic core, a flow channel may be entirely formed by one or more channels in an exterior surface of the coil former such that the flow channel extends from an inlet port on one exterior surface location to another exterior surface location, opposite the inlet location, where a hole or other form for fluid conduit between the channel and the interior of the coil former is provided, such that the fluid conduit is located at a bottom portion of the coil former when the coil former is oriented with the inlet facing upwards. For example, in the example of FIG. 5, the channel 424 may be connected to the channel 425 by a radial channel in the exterior surface of the end wall 115. Yet alternatively, a channel along the outer periphery of the end wall may be provided extending along at least half the circumference 133 of the end wall starting at the inlet location. In yet alternative embodiments one or more circumferential channels way be provided around the circumference of the outer wall 121.

The inlet for inserting a curable material may be located at different locations. In the example described above, only one of the coil former components comprises an inlet port 422. It will be appreciated, however, that alternative embodiments of a coil former may comprise an inlet in each coil former component.

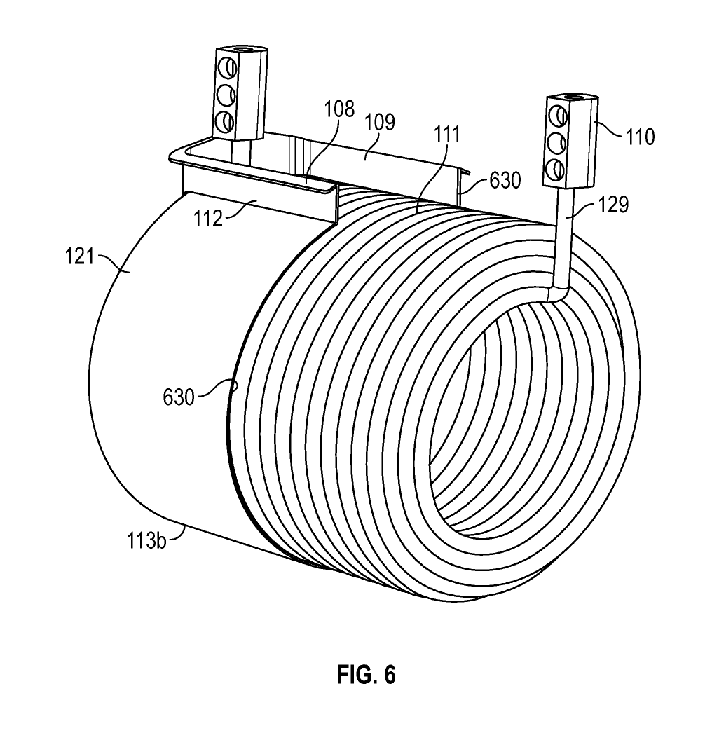

FIG. 6 shows a perspective view of one of the coil former components 113b of the coil former shown in FIGS. 4-5 with a portion of the winding 111 inserted into the void defined by the coil former component 113 but before placing the other coil former component around the portion of the winding 111 that projects out of the open end of coil former component 113b. When the other coil former member is assembled with the coil former component 113b shown in FIG. 6, the rim 630 of the outer wall of coil former component 113b can be slid into the tube defined by the corresponding outer tubular wall of the other coil former component, or vice versa. Similarly, the inner tubular walls of the coil former components may be slid into one another. To this end the diameter of the outer wall of one coil former component may be slightly larger than the diameter of the outer wall of the other coil former component and/or the tubular walls of the coil former components may be made sufficiently flexible/expandable. Similarly, the inner tubular walls may also have slightly different diameters and/or be sufficiently flexible/expandable so as to allow one of the inner tubular walls to be slid into the other. The axial length of the outer walls and the inner walls of the coil former components may be chosen such that they may be slid into one another at variable depths, so as to adapt the axial length of the assembled coil former to windings and magnetic cores of different axial lengths.

It will be appreciated that the outer and/or inner walls of the coil former components may be provided with retaining members, such as snap fit elements, allowing the coil former components to be retained in their assembled configuration once they are slid into each other. For example, such retaining members may be provided at different distances from the rim 630 of the coil former component, so as to allow the coil former components to be assembled and fixed at different insertion depths.

As illustrated by FIG. 6, the slit 109 of coil former component 113b extends all the way from the end wall to the open end of the coil former component as defined by the rim 630 of the outer wall 121. FIG. 6 further shows a lead wire 129 extending from an inner turn of winding 111 radially outwards. In the assembled inductor, as best illustrated in FIGS. 1A-B, the lead wire 129 is accommodated in the void defined by protruding portion 128 of the end wall 115 of the coil former component 113a and one of the recesses 220 in the base core portion 103.

Although some embodiments have been described and shown in detail, the invention is not restricted to them, but may also be embodied in other ways within the scope of the subject matter defined in the following claims. In particular, it is to be understood that other embodiments may be utilized and structural and functional modifications may be made without departing from the scope of the present invention. For example, although an inductive device having circular cross sections has been described in the above, the inventive concept is not limited to this specific shape. For example, the magnetic core and/or the coil former may present an elliptical cross section, a rectangular cross-section, a polygonal cross section etc. without departing from scope of the present inventive concept, as defined in the independent claims.

In device claims enumerating several features, several of these features can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. An inductive device comprising:
a winding defining an axial direction;
a coil former; and
a magnetic core comprising a base core portion from which an outer core portion and an inner core portion extend in the axial direction so as to form a void for accommodating the coil former and the winding;
wherein the coil former defines a void for receiving the winding and separates the winding from the inner core portion and from the outer core portion; wherein the coil former comprises one or more end walls, an inner wall and an outer wall, wherein the inner wall extends in the axial direction from one of the one or more end walls, and the outer wall extends in the axial direction from one of the one or more end walls, wherein the inner wall is interposed between the inner core portion and the winding, and the outer wall is interposed between the outer core portion and the winding.

2. An inductive device according to claim 1, wherein the coil former comprises first and second end walls axially spaced apart from each other; and wherein the inner wall and the outer wall extend in the axial direction between the end walls such that the end walls, the inner wall and the outer wall together form an annular cavity between the inner and outer walls for accommodating the winding.

3. An inductive device according to claim 1, wherein the coil former comprises first and second end walls, an outer wall, and a hollow elongated inner member extending along the axial direction from the first end wall towards the second end wall; wherein the inner member defines an inner void and wherein the inner member and the outer wall together define a void for receiving the winding.

4. An inductive device according to claim 1 wherein the coil former comprises two separate coil former components that are attachable to each other so as to form the assembled coil former component.

5. An inductive device according to claim 3, wherein at least one of the coil former components forms a receptacle for receiving at least a part of the winding.

6. An inductive device according to claim 4, wherein the coil former components each comprises an end wall and an outer wall extending from the end wall in the axial direction; wherein the coil former components each have an open end for receiving the winding so as to allow the coil former components to be fitted over opposite ends of the winding with the open ends of the coil former components facing each other; and wherein the open ends of the coil former components are attachable to each other so as to form an enclosure accommodating the winding.

7. An inductive device according to claim 6, wherein at least a portion of the outer wall of one of the coil former components is axially slidable into the open end of the other coil former component.

8. An inductive device according to claim 7 wherein at least one of the coil former components comprises one or more retaining members configured to retain the other coil former component at one or more selectable insertion depths when a portion of one coil former component is axially inserted into the other coil former component.

9. An inductive device according to claim 6, wherein the outer wall comprises an aperture through which winding leads may project from the winding and out of the coil former, and wherein the outer core portion has an aperture that is axially and circumferentially aligned with the aperture in the outer wall.

10. An inductive device according to claim 9 wherein the coil former comprises a radially outward protruding wall extending along a periphery of the aperture of the coil former.

11. An inductive device according to claim 1 comprising a flow channel extending between an inner surface of the magnetic core and an outer surface of the coil former, the flow channel defining an inlet port for inserting a liquid curable material into the flow channel and allowing the curable material to fill a void between the outer surface of the coil former and the inner surface of the magnetic core.

12. An inductive device according to claim 11 wherein the coil former comprises one or more holes or channels providing a fluid conduit connecting the flow channel with a void defined inside the coil member for accommodating the winding, so as to allow the liquid curable material inserted into the inlet port of the flow channel to enter said void.

13. An inductive device according to claim 1 wherein the coil former comprises one or more mounting elements for connecting one or more electrical connectors.

14. A coil former configured for use in an inductive device as defined in claim 1.

15. A method for manufacturing an inductive device as defined in claim 1, the method comprising:
assembling the magnetic core, the coil former and the winding with each other; and
filling a void inside the magnetic core with a curable material.

16. A method according to claim 15 wherein the inductive device comprises a flow channel extending between an inner surface of the magnetic core and an outer surface of the coil former, the flow channel defining an inlet port for inserting a liquid curable material into the flow channel and allowing the curable material to fill a void between the outer surface of the coil former and the inner surface of the magnetic core; wherein the method comprises: inserting the liquid, curable material into the inlet port when the assembled combination of magnetic core, coil former and winding is placed with an aperture formed in the outer core portion of the magnetic core facing upwards.
